(19) United States
(12) Patent Application Publication
(10) Pub. No.: US 2026/0266215 A1
(43) Pub. Date: Sep. 10, 2026

(54) AXIAL INTERNAL COMBUSTION ENGINE

(71) Applicant: INNENGINE, S.L., ARMILLA (ES)

(72) Inventor: Juan GARRIDO REQUENA, GRANADA (ES)

(21) Appl. No.: 18/868,902

(22) PCT Filed: Jun. 8, 2023
(86) PCT No.: PCT/EP2023/065408

§ 371 Date: Nov. 25, 2024

(30) Foreign Application Priority Data
Jun. 9, 2022 (EP) 22382557.1

(51) Int. Cl. F02B 75/26; F02B 75/02

(52) U.S. Cl. CPC F02B 75/26; F02B 2075/023

(57) ABSTRACT

The axial internal combustion engine comprises at least one cylinder (100), a piston assembly (110) within the cylinder defining a combustion chamber (200) where a fuel-air-oil mixture is compressed in one stroke of the piston assembly (110), and a pump chamber (300) for the suction of air to be drawn into the combustion chamber (200) in said stroke of the piston assembly (110) for subsequent explosion of the fuel-air-oil mixture compressed in the combustion chamber (200). The piston assembly (110) comprises a piston head (111), a piston body (112), and a connecting rod (135) connected to the piston head (111) and with a cam follower (150) at one end (140) to bear on a surface (410) of a single power cam (400). Displacement of the piston assembly (110) within the cylinder (100) causes the cam follower (150) to roll onto surface (410) causing power cam (400) to be rotated.

### FIELD OF THE INVENTION

This application claims the benefit of the European Patent application EP22382557.1 filed 9 Jun. 2022

The present disclosure relates engines. More particularly, the present disclosure relates to axial internal combustion engines. The present internal combustion engine may be applied to cars, flying vehicles such as model airplanes, and many other different applications.

### BACKGROUND

The present axial internal combustion engine may be referred to as one stroke combustion engine. One-stroke internal combustion engines are known in the art. In one-stroke internal combustion engines, one combustion is produced per piston stroke. The intake, compression, power, and exhaust strokes occur in a single turn of an output shaft or crankshaft. Every piston stroke is the power stroke so that only one power stroke is required to rotate the output shaft or crankshaft continuously to complete a full cycle.

One example of a one-stroke internal combustion engine is disclosed in US20030121482A1. The engine comprises a combustion chamber and a compression chamber. A compression member is provided within the compression chamber for defining first and second combustion sub-chambers. A piston is slidably disposed within the combustion chamber in communication with the compression member for defining the first and second combustion sub-chambers. Motion of the piston toward the first combustion sub-chamber enables a first fuel-air mixture to flow into the second combustion sub-chamber from the second combustion sub-chamber for subsequent combustion therein together with drawing of a second fuel-air mixture into the first compression chamber. Motion of the piston toward the second combustion sub-chamber enables the second fuel-air mixture to flow into the first combustion sub-chamber from the first combustion sub-chamber for subsequent combustion therein together with drawing of a third fuel/air mixture into the second compression chamber.

A further example of a one-stroke internal combustion engine is disclosed in US2016025001A1. It comprises intake, compression, combustion and exhaust chambers operating with a linear, rotary or opposed piston configuration. A crankshaft is driven as pistons are alternately ignited.

EP3066312B1, filed by the same applicant as the present application, refers to an opposed piston engine capable of completing the entire cycle in just one time. For this purpose, mutually opposed power cams are connected to respective rotary shafts such that reciprocation of pistons acting on power cams imparts a rotating motion to the rotary shafts to drive the engine.

Axial or barrel engines are known in the art such as the one disclosed in U.S. Pat. No. 1,042,018 having cylinders arranged around and parallel to a central shaft, like the chambers in the cylinder of a revolver. Although such motors have low frontal area with very good balance and great compactness, problems, such as poor access for maintenance, are usually found on the swashplate that is used for converting the piston thrust into rotary motion.

Although known one-stroke internal combustion engines have been shown to provide a number of significant benefits, such as smaller displacement and lower emissions, there still remains a need for a simpler engine that requires much fewer auxiliary parts and higher specific power and higher power to weight ratio.

### SUMMARY

An axial internal combustion engine is disclosed herein with which at least the above needs are met and with which further advantages and benefits are obtained.

The present axial internal combustion engine comprises at least one cylinder, such as two or four. Other suitable number of cylinders are possible. The cylinders may be arranged to work in any desired position, such as horizontal vertical or inclined.

A piston assembly is slidably received within each cylinder. Thus, the present axial internal combustion engine comprises as many piston assemblies as cylinders. The piston assembly defines, within the cylinder, a combustion chamber and a pump chamber. The present engine in referred herein to as axial internal combustion engine since the pump chamber within the cylinder is arranged axially relative to the combustion chamber. An engine mount is provided for supporting the cylinder or cylinders. The engine mount may have an opening for receiving the piston body.

The pump chamber is intended for suction of air to be pumped into the combustion chamber. The combustion chamber is intended for compressing a fuel-air-oil mixture in one stroke of the piston assembly and subsequent explosion of the compressed fuel-air-oil mixture.

The piston assembly comprises a piston head, a piston body, and a connecting rod. The connecting rod has a first end that is connected to the piston head. A cam follower is attached to the piston body. The cam follower may be, for example, a roller rotatably mounted in the piston body.

The piston head is preferably frusto-conical in shape. The connecting rod is connected to the piston head and the piston body so that swinging is limited. Loads are therefore withstood by the piston body and not by the piston head with no side loads being present against the cylinder and therefore with less wear. Fitting of the piston assembly within the cylinder is facilitated and opening and closing of ports are more effective.

A single power cam is provided. The above mentioned cam follower provided at the second end of the connecting rod is intended to bear directly, i.e. to roll, on a surface of said single power cam. A roller bearing is preferably provided for rotation of the single power cam.

The piston assembly is configured to move along a first direction inside the cylinder causing a fuel-air-oil mixture to be drawn into the pump chamber through intake ports while transfer and exhaust ports are closed, then to move along a second, opposite direction, for pumping the fuel-air-oil mixture into the combustion chamber through transfer ports, then to move again along the first direction where the fuel-air-oil mixture is compressed by the piston assembly within the combustion chamber, and then to move again along the second direction inside the cylinder due to ignition of the compressed fuel-air-oil mixture, performing the power stroke and opening the exhaust ports such that combustion gases are exhausted out from the combustion chamber. Fresh fuel-air-oil mixture is then pumped again into the pump chamber for subsequent cycle.

Displacement of the piston assembly within the cylinder along the second, opposite direction causes the cam follower to roll onto the surface of the single power cam causing the single power cam to be rotated. This, in turn, causes an output shaft connected to the single power cam to be rotated. This is repeated for subsequent strokes of the piston assembly.

Counter cams may be provided in the output shaft for receiving corresponding counter cam followers that are mounted in the piston body coaxially with the cam followers of the piston assembly. The diameter of the counter cams is smaller than the diameter of the power cams. The counter cams are intended to prevent piston assemblies from losing contact with the single power cam.

With the configuration as described above, no crankshaft is required so that an advantageous compact design is achieved with a high power to weight ratio. Provision of a single power cam results in an efficient, robust engine with improved mass balance and low vibrations.

Within the meaning of the present disclosure, a one-stroke refers to an engine that requires one single power stroke to rotate the power cam 180° completing the cycle.

The cam follower may be provided with at least one channel for the passage of lubricant. Also, the cam follower may preferably be arranged to act close to a central area of the surface of the single power cam. Other configurations are possible.

As stated above, a number of cylinders may be provided each with a corresponding piston assembly slidably received there within. In that case, still a single power cam is associated with all the piston assemblies. Also in that case, a pump chamber and a combustion chamber as stated above are defined by each piston assembly within each cylinder.

The cylinder may include a single crankcase that is part of the pump chamber. Said single crankcase is associated with a piston assembly. A common crankcase for the cylinders may be provided. Said common crankcase may be integrally formed with the engine mount, or it may be a separate part.

Fuel control means are preferably provided for adjusting the amount of fuel and/or air entering the cylinders. The fuel control means may be, for example, at least one carburetor, or a fuel injection system. In any case, it may be advantageous that the fuel control means are arranged in the above mentioned common crankcase, if provided.

At least one intake port may be provided for the intake of the fuel-air-oil mixture into the pump chamber of the cylinder. At least one transfer port may be provided for the flow of the fuel-air-oil mixture from the pump chamber into the combustion chamber of the cylinder. At least one exhaust port may be provided for the exhaust of combustion gases out of the engine. The exhaust port may be preferably arranged to open before the transfer port opens and to close after the transfer port closes.

One or more longitudinal guides may be advantageously provided for guiding the piston body of the piston assembly as it is moved within the cylinder. Optimally, at least one longitudinal guide provided in an outermost part of the engine mount is larger than other longitudinal guides arranged at other locations of the piston assembly.

In the axial internal combustion engine described above, a clearance volume, that is, a part of the cylinder volume that is not swept by the piston, is advantageously very small. This results in a higher compression ratio, volumetric efficiency, and enhanced cooling capacity. In has been found that, for the same power, costs are significantly lower as compared to standard internal combustion engines. The present engine is lightweight, and it easily spins up which is beneficial in flying vehicles such as model airplanes. The present engine also finds advantageous application in cars and many other.

### BRIEF DESCRIPTION OF THE DRAWINGS

A non-limiting example of the present axial internal combustion engine will be described in the following, with reference to the appended drawings.

In the drawings:

FIG. 1 is a general perspective view of one example of the present axial internal combustion engine;

FIGS. 2 and 3 are elevational and side views, respectively, of the example of the internal combustion engine shown in FIG. 1;

FIGS. 4 and 5 are sectional views of the axial internal combustion engine shown in FIGS. 1-3;

FIG. 6a is a perspective view of the axial internal combustion engine shown in FIGS. 1-5 with the cylinders removed to show the piston assemblies;

FIG. 6b is a fragmentary perspective view of one of the piston assemblies shown in FIG. 6a;

FIGS. 6c and 6d are perspective views of a cylinder where transfer ports and the exhaust ports are shown;

FIGS. 7-10 are top, bottom, perspective, and side views of a piston assembly with the cylinders removed in order to show the piston assemblies;

FIGS. 9a-9c show parts of the piston assembly for illustrating how the piston head is connected with the connecting rod;

FIGS. 11 and 12 are perspective views showing the single crankcase taken from different sides;

FIGS. 13 and 14 are fragmentary perspective views showing the piston assembly engine taken from different sides;

FIGS. 15 and 16 are perspective views showing the engine mount taken from different sides; and

FIGS. 17 and 18 are perspective views of the single power cam.

### DETAILED DESCRIPTION OF ONE EXAMPLE

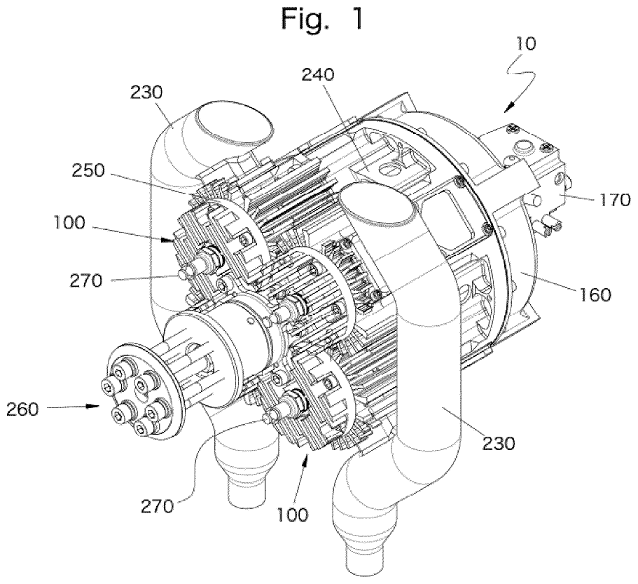

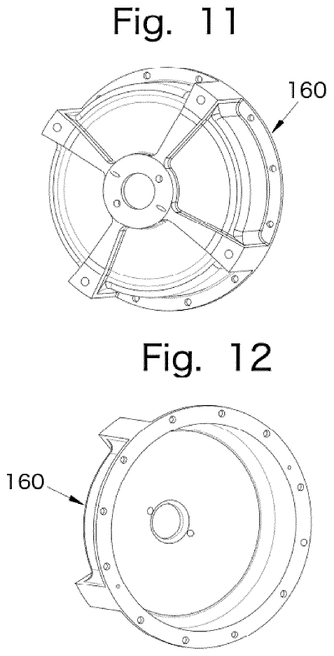

A non-limiting example of an axial internal combustion engine 10 for a model airplane is shown in FIGS. 1-16 of the drawings and described below.

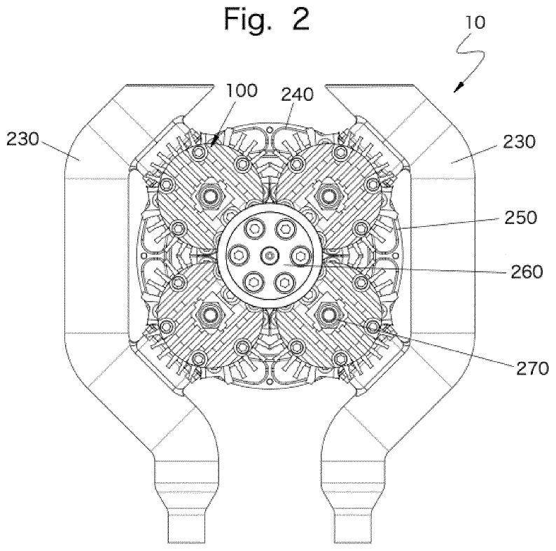

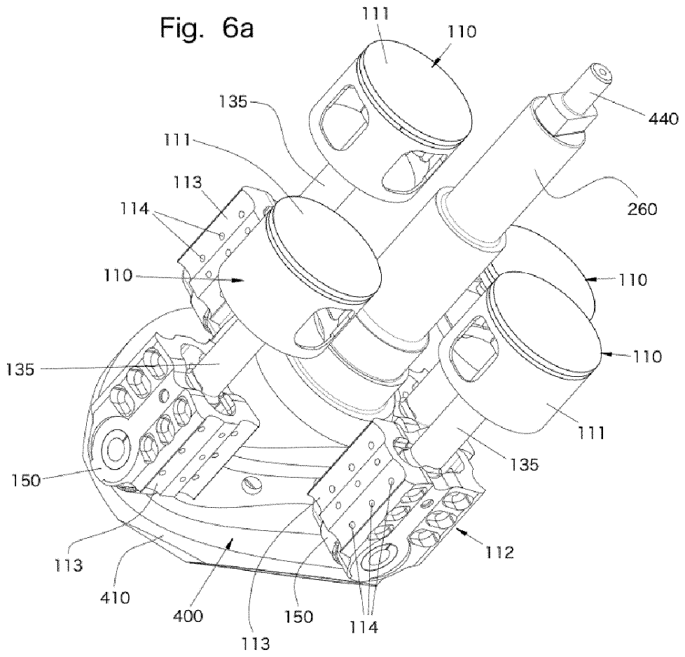

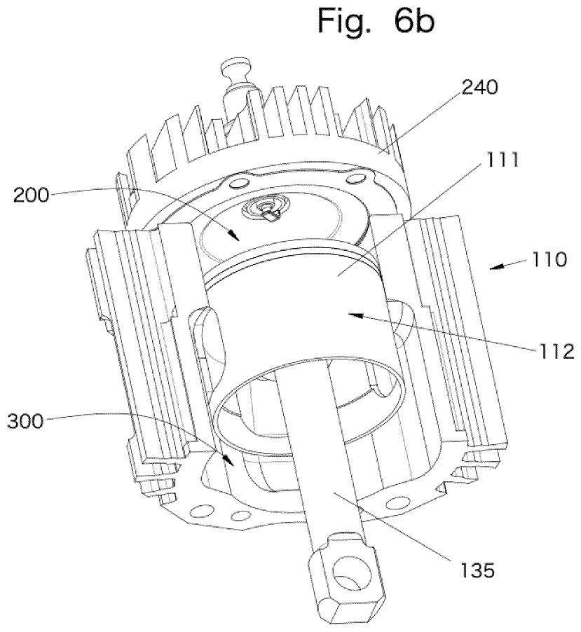

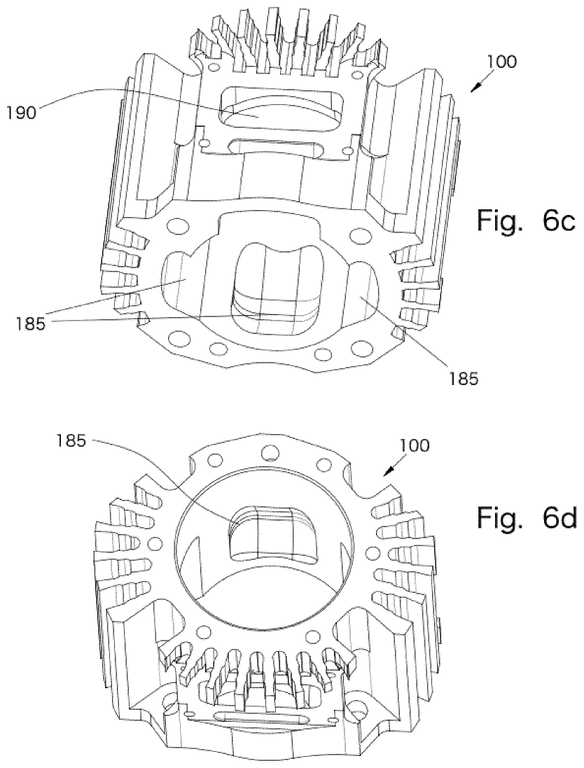

The axial internal combustion engine 10 comprises four cylinders 100 each having a cylinder head 250 as shown in FIGS. 1 and 2. The cylinders 100 are supported by an engine mount 240 as shown in FIGS. 1-3 of the drawings. A different number of cylinders 100 is of course possible depending on the specific application of the engine 10. As shown in FIG. 6, the engine mount 240 has an opening 500 suitable for receiving the piston body 112. The piston body 112 can be thus fully received into the engine mount 240. The opening 500 is defined by spaced apart walls 510 inside the engine mount 240.

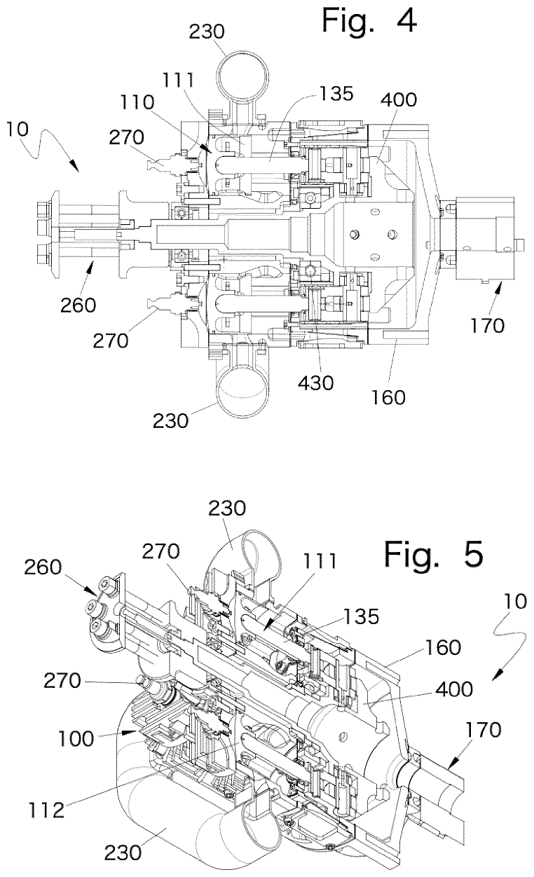

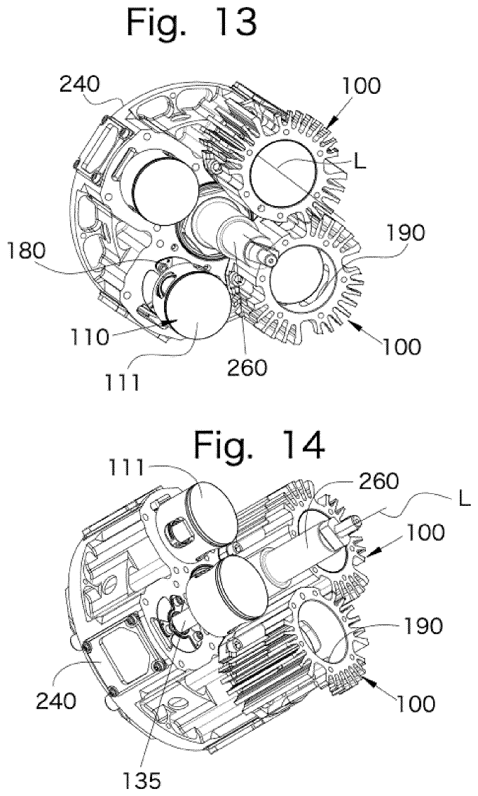

Within each cylinder 100, a piston assembly 110 is slidably received as shown in FIGS. 4-5. The piston assembly 110 is shown in detail in FIGS. 6-10 of the drawings. In use, the piston assembly 110 reciprocates along a longitudinal axis L of the cylinder 100 depicted in FIGS. 13 and 14 of the drawings.

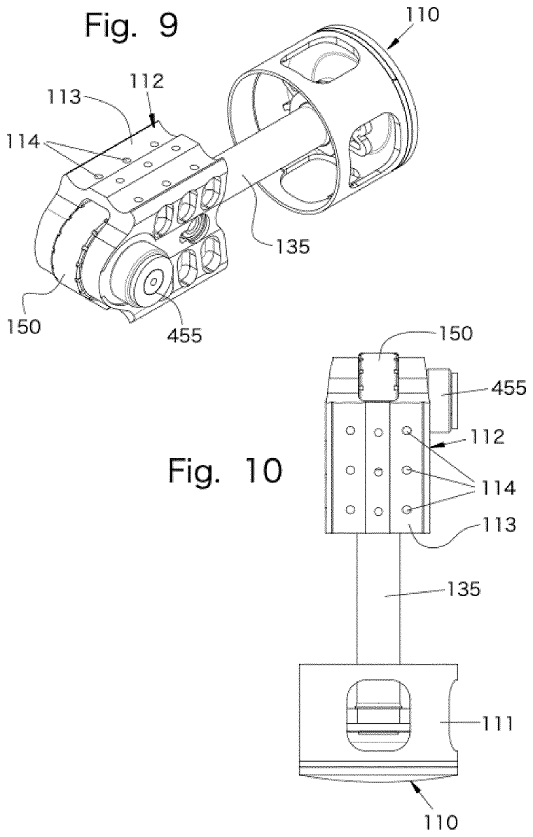

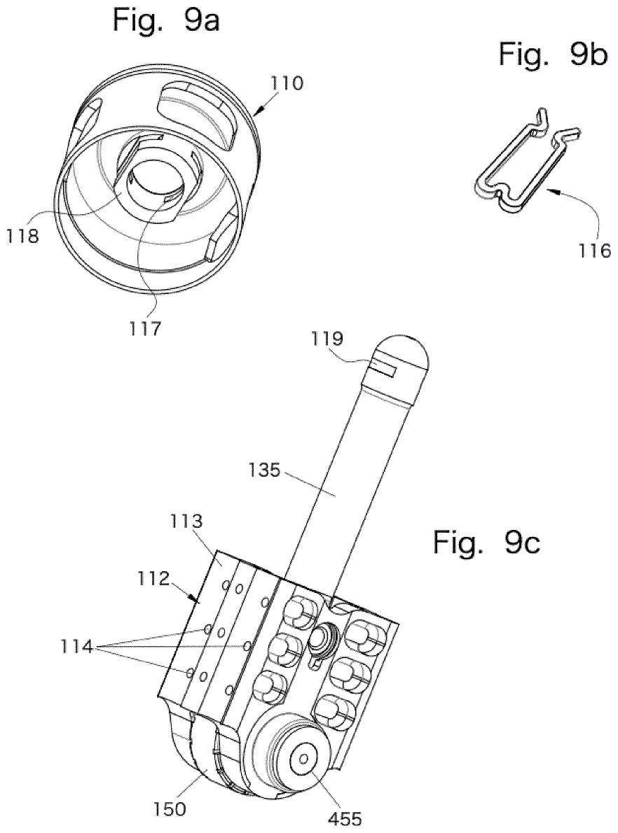

As shown in FIGS. 6a-10, the piston assembly 110 comprises a piston head 111, a piston body 112, and a connecting rod 135. A cam follower 150 is attached to the piston body 112. In use. the connecting rod 135 connects the piston head 111 with the piston body 112 together, as shown in FIGS. 1-3. In particular, referring to FIGS. 9a, 9b and 9c of the drawings, the connecting rod 135 has one end connected to the piston head 111 through a connecting clip 116. The connecting clip 116 has two arms, as shown in FIG. 9b. In use, the arms of the connecting clip 116 pass through an opening 117 formed in a connecting body 118 formed inside the piston head 111. In turn, the arms of the connecting clip 116 are received into and press against an annular groove 119 formed said end of the connecting rod 135, as shown in FIGS. 9a, 9b and 9c. In this way, the connecting rod 135 is connected to the piston head 111 with a little swinging freedom.

As shown in FIG. 6b, each piston assembly 110 defines, within the corresponding cylinder 100, a combustion chamber 200 and a pump chamber 300.

The combustion chamber 200 may be also referred herein to as compression chamber since it is configured to receive a fuel-air-oil mixture to be compressed by the piston assembly 110 in one stroke of the combustion engine 10.

The pump chamber 300 is arranged axially relative to the combustion chamber 200 along said longitudinal axis L of the cylinder 100. The pump chamber 300 may be also referred to as sweeping chamber since it is configured to draw air there from a common crankcase 160 into the combustion chamber 200 in the stroke of the combustion engine 10.

Reference is now made to FIGS. 6a-10 of the drawings where the piston assembly 110 is shown with the piston head 111 connected with the piston body 112 through the connecting rod 135 as described above. The connecting rod 135 has a first end that is connected to the piston head 111 and a second end that is connected to the piston body 112.

A number of parallel channels 113, shown in detail in FIGS. 9 and 10, are provided in the piston body 112. The channels 113, in turn, are provided with ports 114 for cooling and delivery of lubricant. The channels 113 in the piston body 112 are configured for receiving longitudinal guides 115 formed in the engine mount 240 as shown in FIG. 16. In use, the longitudinal guides 115 guide the piston body 112 as it is moved within the engine mount 240. Longitudinal guides 115 located at an outermost part of the engine mount 240 are larger than other longitudinal guides 115 located at other locations of the engine mount 240.

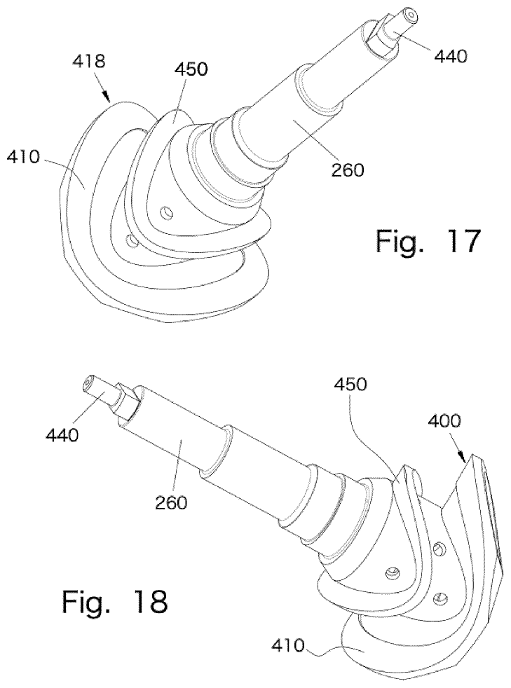

A single power cam 400 is provided as shown in FIGS. 17 and 18. The single power cam 400 is attached to an output shaft 440. The output shaft 440 is in turn attached to a propeller carrier as shown in the figures.

The above mentioned cam follower 150 of each piston assembly 110 is intended to bear directly on a surface 410 in the single power cam 400. In particular, the cam follower 150 is arranged to act close to a central area of the surface of the single power cam 400. In operation, a displacement of the piston assembly 110 within the cylinders 100 causes the cam follower 150 of the piston assembly 110 to roll onto said surface 410 of the single power cam 400 causing the single power cam 400 with the output shaft 440 to be rotated together. The single power cam 400 is supported in rotation by a roller bearing 430 as shown in FIG. 4.

As a result of the above configuration, no crankshaft is required so a compact design is achieved with a high power to weight ratio and an improved mass balance with low vibrations.

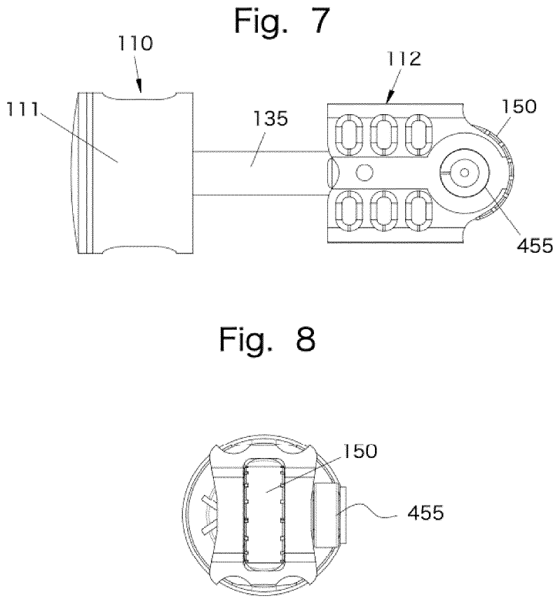

Referring now to FIGS. 17 and 18, counter cams 450 are formed in the output shaft 440. Counter cams 450 are intended to receive corresponding counter cam followers 455. The opening 500 in the engine mount 240 is suitable for receiving the counter cams 450. As shown in FIGS. 7-10, counter cam followers 455 are mounted in the piston body 112 coaxially with the cam followers 150 of the piston assembly 110. As shown in FIGS. 7-10, the diameter of the counter cams 450 is smaller than the diameter of the power cam 400. The counter cams 450 are intended to prevent piston assemblies 110 from losing contact with the single power cam 400.

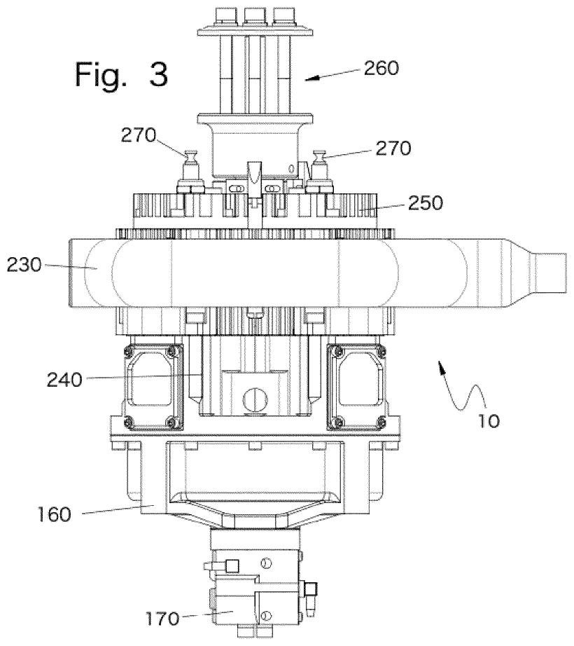

Each cylinder 100 includes a single crankcase that is part of the pump chamber 300. Further, the above mentioned common crankcase 160 that is part of the engine mount 240 is also provided as shown in FIGS. 1 and 3 of the drawings.

For adjusting the amount of fuel and/or air entering the cylinders 100, in particular, entering the pump chamber 300 of cylinders 100, fuel control means 170 are provided in the above mentioned common crankcase 160. In the non-limiting example shown in the figures, the fuel control means 170 comprises one or more carburetors. Other fuel control means 170, for example, based on fuel injection, may be possible.

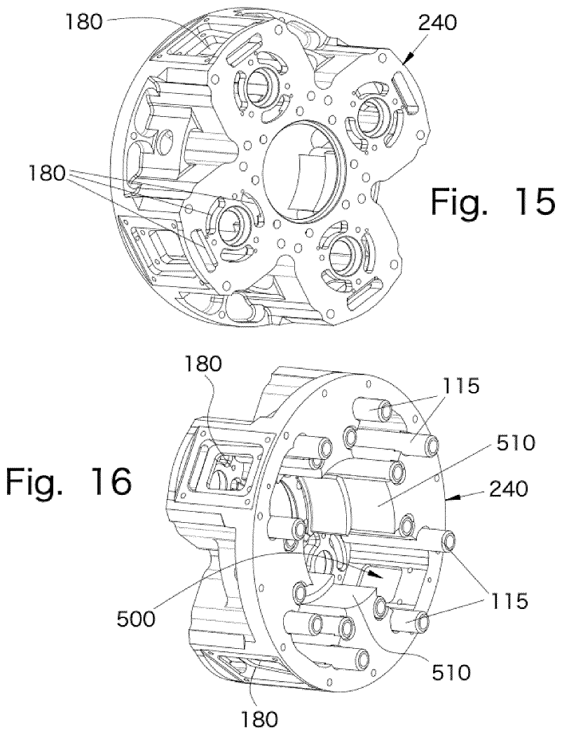

Intake of a fuel-air-oil mixture into the pump chamber 300 is carried out through intake ports 180 formed in the engine mount 240 as shown in FIGS. 15 and 16. Transfer ports 185 are provided for the flow of the fuel-air-oil mixture from the pump chamber 300 into the combustion chamber 200 within the cylinders 100 as shown in FIGS. 6c and 6d. Exhaust ports 190 shown in FIGS. 6c, 13 and 14 are also provided for the exhaust of combustion gases out of the engine 10 through corresponding exhaust pipes 230. The exhaust ports 190 are arranged to open before the transfer ports 185 open and to close after the transfer ports 185 close.

In operation, the piston assembly 110 first moves along a first direction inside the cylinder along said longitudinal axis L of the cylinder 100 causing a fuel-air-oil mixture coming from carburettors 170 to be drawn into the pump chamber 300 through intake ports 180 while transfer ports 185 and exhaust ports 190 are closed. The piston assembly 110 then moves along a second, opposite direction along said longitudinal axis L of the cylinder 100 pumping the fuel-air-oil mixture through transfer into the combustion chamber 200. The piston assembly 110 then moves again along the first direction where the fuel-air-oil mixture is compressed by the piston assembly 110 within the combustion chamber 200. Finally, the piston assembly 110 moves along the second direction inside the cylinder 100 due to ignition of the compressed fuel-air-oil mixture by spark plugs 270 performing the power stroke and opening the exhaust ports 190 such that combustion gases are exhausted out from the combustion chamber 200 through exhaust pipes 230. Fresh fuel-air-oil mixture is then pumped again into the pump chamber 300 for subsequent cycle. This is repeated for subsequent strokes of the piston assembly 110 causing the cam followers 150 to roll onto the surface 410 of the single power cam 400 so that the single power cam 400 is rotated and thus the output shaft 440 that is connected thereto.

As the piston assembly 110 moves within the cylinder 100, the transfer port 185 and the exhaust port 190 are opened and closed correspondingly. An intake leaf valve is provided in the intake port 180 that is driven as the piston assembly 110 moves within the cylinder 100. The intake leaf valve opens and closes under internal pressure on the cylinder 100.

Although one example of the present internal combustion engine has been disclosed herein, other alternatives, modifications, uses and/or equivalents thereof are possible. All possible combinations of the example described herein are also covered. For example, a suitable number of cylinders other than four is possible.

The scope of the present disclosure should not be limited by the particular example disclosed herein but should be determined only by a fair reading of the claims that follow.

Reference signs related to drawings placed in parentheses in a claim are solely for attempting to increase the intelligibility of the claim, and shall not be construed as limiting its scope.

1. Axial internal combustion engine comprising:
at least one cylinder supported by an engine mount;
a piston assembly slidably received within the cylinder defining a combustion chamber and a pump chamber arranged axially relative to each other, the piston assembly being configured to move along a first direction inside the cylinder causing a fuel-air-oil mixture to be drawn into the pump chamber, then to move along a second, opposite direction, for pumping the fuel-air-oil mixture into the combustion chamber, then to move again along the first direction where the fuel-air-oil mixture is compressed by the piston assembly within the combustion chamber, and then to move again along the second direction inside the cylinder due to ignition of the compressed fuel-air-oil mixture,
wherein the piston assembly comprises:
a piston head,
a piston body, and
a connecting rod having an end connected to the piston head;
a cam follower attached to the piston body to bear directly on a surface of a single power cam, whereby displacement of the piston assembly within the cylinder causes the cam follower to roll onto the surface of the single power cam causing the single power cam to be rotated.

2. The engine of claim 1, wherein the engine mount has an opening for receiving the piston body.

3. The engine of claim 1, wherein the engine comprises a number of the cylinders each having a corresponding piston assembly and the single power cam associated with the piston assemblies, a pump chamber and a combustion chamber being defined by each piston assembly within each cylinder.

4. The engine of claim 1, wherein the engine includes a fuel control device for adjusting the amount of fuel and/or air entering the cylinder.

5. The engine of claim 4, wherein the fuel control device comprises at least a carburetor or a fuel injection system.

6. The engine of claim 1, wherein the engine includes a common crankcase for the cylinder.

7. The engine of claim 6, wherein the engine includes a fuel control device and wherein the fuel control device is arranged in the common crankcase.

8. The engine of claim 1, wherein the cylinder further includes at least one intake port for the intake of the fuel-air-oil mixture into the pump chamber of the cylinder, at least one transfer port for the flow of the fuel-air-oil mixture from the pump chamber into the combustion chamber of the cylinder, and at least one exhaust port for the exhaust of combustion gases from the combustion chamber.

9. The engine of claim 8, wherein the exhaust port is arranged to open before the transfer port opens and to close after the transfer port closes.

10. The engine of claim 1, wherein the cam follower is provided with at least one channel for the passage of lubricant.

11. The engine claim 1, wherein the cam follower is arranged to act close to a central area of the surface of the single power can.

12. The engine of claim 1, wherein the engine includes a roller bearing for rotation of the single power cam.

13. The engine of claim 1 wherein a connecting rod is provided for connecting the piston head with the piston body

14. The engine of claim 1, wherein at least one longitudinal guide is provided for guiding the piston body of the piston assembly as the piston body is moved within the engine mount.

15. The engine of claim 14, wherein a number of the longitudinal guides are provided for guiding the piston body of the piston assembly as the piston body is moved within the engine mount, at least one of the longitudinal guides located in an outermost part of the engine mount being larger than the other longitudinal guides.
